(19) United States
(12) Patent Application Publication
(10) Pub. No.: US 2003/0019923 A1
(43) Pub. Date: Jan. 30, 2003

(54) Unification code program recorded storage medium and unification code system

(75) Inventor: Sang-Chan Park, Sungnam-City (KR)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: Siri Co., Ltd.

(21) Appl. No.: 10/259,898

(22) Filed: Sep. 27, 2002

Related U.S. Application Data
(63) Continuation of application No. 09/607,395, filed on Jun. 30, 2000, now abandoned.

(30) Foreign Application Priority Data
Jun. 5, 2000 (KR) 2000-30875

(51) Int. Cl. G06F 17/00

(52) U.S. Cl. 235/375

(57) ABSTRACT

This invention is about article codes (namely, barcodes) which identify the products. More specifically, this invention is about the system and the Storage Medium with the unification code-generating program, which will make it possible to uniquely identify various article codes that have been standardized and used by each country, each region and each organization irrespective of countries, regions and organizations.

### CROSS-REFERENCE TO RELATED APPLICATIONS

This application is a continuation of U.S. patent application Ser. No. 09/607,395, filed Jun. 30, 2000 which claims priority to Korean Application No. 2000-30875, filed on Jun. 5, 2000 which applicants are hereby incorporated by reference.

### BACKGROUND OF THE INVENTION

1. The Field of the Invention

This invention is about article codes (namely, barcodes) which are printed in the products or their wrappers to manage manufactured products. More specifically, this invention is about the system and the Storage Medium with the unification code-generating program operated by computer, which will make it possible to uniquely identify various article codes that have been standardized and used by each country, each region and each organization irrespective of countries, regions and organizations.

2. The Relevant Technology

Recently, as many businesspeople better understand the Business-to-Business Electronic Commerce (B2B EC), they start to develop core technology needed in B2B EC, and the companies' interest toward the foreign markets make them form the global economic block.

To effectively carry out B2B EC, it is essential to construct the article catalog that should be set on the basis of easiness in searching and convenience in use, ultimately, which should be able to assist in users' decision making.

The code that is used to manage the article catalog as mentioned above is the article code that is generally called the barcode.

The article codes are standardized and used independently by each country, each region and each organization.

There are internationally standardized four article code systems that are most commonly in use; U.S. exports and imports codes such as HTS, Schedule B, C and K types; NAICS and SIC types in Thomas Registry; UN/SPSC types in Rosettanet Consortium; and Barcode types such as EAN, KAN, UPC, and GADS.

When we compare these independently standardized article codes, we can find some drawbacks. Since the number of digits representing article codes is limited, it is difficult to expand the article codes when additional products are added to the system. Not to mention the total numbers of digits for each representative article code systems are different from one system to another, the location and the order of the digits that represent the same characteristics of the same product are different from one another. For example, the HTS, NAICS, UN/SPSC and KAN numbers for representing an article ‘Y-shirt’ are 6205202022 (10 digits), 315223 (6 digits), 53101602 (8 digits) and 510407 (6 digits), respectively. In these codes, the attribute meaning ‘garment’ is represented respectively as 62, 315, 53 and 5 and this means by that the different numbers of digits are needed to represent the same attribute. And, as we may see in the underlined parts of the codes 6205202022, 315223, 53101602 and 510407 which represent the attribute ‘gender’, the locations of the digits representing the same characteristics are different. And, finally, of those 4 article codes, HTS also represents the attribute ‘material’, the underlined part of the code 6205202022, in which other system does not contain and this means by that even abstract levels of article characteristic representations are different.

As we have compared above, the inconsistency in the article codes hinder the information interchange between companies adopting different system in B2B EC in a global setting.

### BRIEF SUMMARY OF THE INVENTION

To resolve the problem stated in detail, the object of this invention is to provide the Storage Medium with a program that integrate each article code which is standardized by each country, each region and each organization and defines the unification code that will be usable globally irrespective of countries, regions or organizations.

Another object of this invention is to provide the article unification code system that can identify individually standardized article codes and generate a unification code.

It is a further object of this invention to furnish information on articles to the users effectively in carrying B2B EC. In accordance with the object(s) of this invention, as embodied and broadly described herein, this invention, in one aspect, relates to the computer readable Storage Medium with the Unification code generating program comprise;

(a) a first step of extracting unifiable descriptors that are existed in each target article code and then generating code masks for each code;

(b) a second step of defining general descriptors and discriminant descriptors by comparing the code masks generated at the first step;

(c) a third step of constructing unification code mask nodes by using the abstracted discriminant descriptors and then constructing a network between the unification code mask nodes and generating a unification code mask by using the network; and

(d) a fourth step of defining unification code objects by using the unification code mask generated at the second step.

The invention further relates to the unification code system comprising:

a computer that mount the Storage Medium with a Unification code-generating program;

means for inputting each internationally standardized article code, the means is connected to the said computer; and

means for generating the article codes as a unification code by using the unification code generating program in the said Storage Medium mounted in the computer.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows a flow diagram of process to define the unified code objects modeled in this invention.

FIGS. 2A and 2B show a completed unification code of articles of clothing.

### DETAILED DESCRIPTION OF THE PREFERRED EMBODIMENTS

This invention considering the internationally standardized article code systems defines the unified code objects through four steps of processes.

The four steps consist of the following; at the first step, extract the unifiable descriptors that are existed in each target article code and then generate the code masks for each code; at the second step, define general descriptors and discriminant descriptors by comparing the code masks generated at the first step; at the third step, constructing unification code mask nodes by using the abstracted discriminant descriptors and then constructing a network between the unification code mask nodes and generating a unification code mask by using the network; and, at the fourth step, define the unification code objects by using the node of the unification code mask generated at the second step.

As the target codes to apply this invention, we have considered thirteen commonly used standardized article code systems that are part of four major classes. They are; 1) U.S. Exports and imports codes such as HTS, Schedule B, C and K types; 2) NAICS and SIC types in Thomas Registry; 3) UN/SPSC types in Rosettanet Consortium; and 4) Barcode types such as EAN, KAN, UPC, UCC and GADS.

Following is the detailed explanation for the attached drawing.

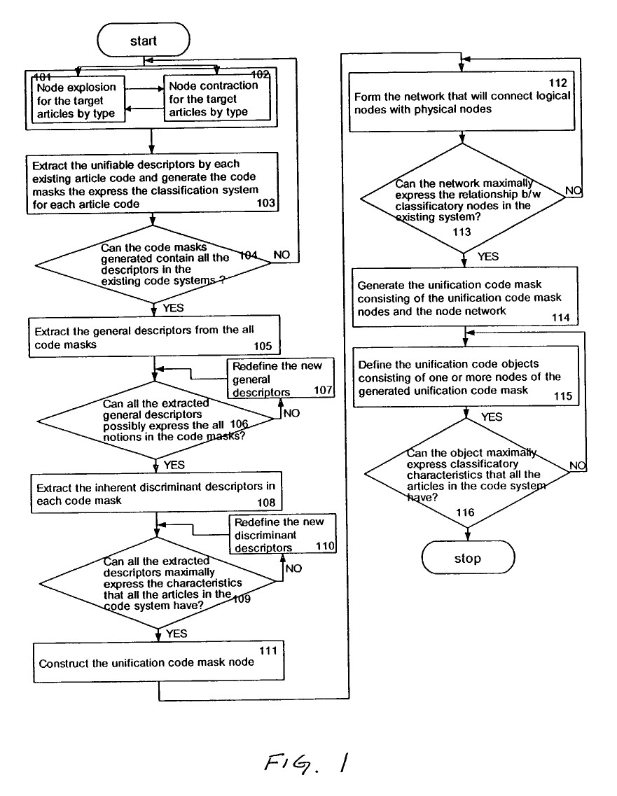

FIG. 1 shows a flow diagram of process to define the unified code objects modeled in this invention.

Before defining the unified code objects, select the target codes and then decide detailed target areas such as articles of clothing, electronics, etc.

After deciding the detailed target areas, iteratively perform the node explosion process (101) and the node contraction process (102) for the target articles by type. As for the nodes, as we will see in the examples of ‘Y-shirt’ below, each node represents the classificatory and expressional characteristics of the target article such as clothing, gender, material and processing, etc. The node contraction process is the process that, after being extracted from the target codes, nodes with similar characteristics are bound together, which make it easy to unify various codes into one unification code. And, contrary to the node contraction process, the node explosion process is the process that the nodes that do not exist in the current classification but are thought to be essential for the purpose of the future use are generated.

Extract the unifiable descriptors by each existing article code by performing the node explosion process and the node contraction process iteratively and then, on the point of unification view, generate the code masks that express the classification system for each article code and that provide the View by code (103). Evaluate whether or not the code masks generated can contain all the descriptors in the existing code systems (104). Perform the process extracting the general descriptors from the code masks when it is estimated that the code masks generated can contain all the descriptors in the existing code systems (105); otherwise re-perform the node explosion process and the node contraction process and then regenerate the code masks.

In what follows, judge that all the extracted general descriptors stated above (105) can possibly express all the common notions in the code masks (the classificatory characteristics that will be commonly existed in the target code masks) (106), and, if so, extract the inherent discriminant descriptors in each code mask (108); otherwise, iteratively redo the process for redefining the new general descriptors (107) until extracted discriminant descriptors maximally express all the common notions. Then, general descriptors will be extracted with the help of Code Description and/or by the node raising process. Here, Code Description is the specific descriptions of the areas to identify the articles, and the node raising process is the process to raise the logical digit of the code according to their commonness and importance within the unification code mask.

If inherent discriminant descriptors within each code mask, which are not the classificatory characteristics commonly existing in all the code masks but are the characteristics inherently existing in each code mask, are extracted by reflecting the common notions for all the code masks, Perform the process of evaluating whether or not those descriptors can maximally express the characteristics that all the articles in the code system have (109). If those descriptors can maximally express the characteristics, construct the unification code mask node (111); otherwise, iteratively re-perform the process of deciding the new discriminant descriptors until such descriptors maximally express all the common notions (110). Then, general descriptors will be extracted with the help of Code Description and/or by the node lowering process. Here, the node lowering process, contrary to the node raising process, is the process of lowering the logical digit of the code to unify a node ranked high in an individual code mask with other nodes with different code masks.

Perform the process to generate the unification code mask with general descriptors and discriminant descriptors (111). When we combine the node extracted to express all the properties of the articles and realize these at the unification code mask level, since the digits of the existing systems are automatically decided by the linkage between nodes, the network that will connect logical nodes (the unification code meta-model) with physical nodes (the code digits in the existing systems) will be formed (112).

Perform the process of judging that the above node network can maximally express the relationship between classificatory nodes in the existing system (113), and, if so, generate the unification code mask which consists of the unification code mask nodes and the node network (114); otherwise, reconstruct the network between unification code mask nodes.

Perform the unification code mask generating process (114), and then define the unification code objects consisting of one or more nodes of the generated unification code mask (115). Perform the process of evaluating whether or not the above objects maximally express the classificatory characteristics that all the articles in the code system have (116); if so, complete the above process; otherwise, redefine the unification code objects.

As we have stated above, we could define the unification code objects by the process of inputting the individually standardized article code

We will show the process of defining the unification code by exemplifying the articles of clothing in four major code systems such as HTS, NAICS, UN/SPSC and KAN.

First of all, perform the node explosion process and the node contraction process for the articles of the clothing and generate the code masks for each code system. For example, in UN/SPSC codes that are 8-digit code systems, the descriptors such as ‘clothing’, ‘gender’, ‘material’, ‘processing’ and ‘specific name’ are classified as the same higher nodes. And, of these, after redefining the descriptors ‘clothing’ and ‘specific name’ as ‘kind’ via node contraction process and then generate the code mask in which the descriptors ‘kind’ and ‘object’ are classified as higher nodes.

In KAN code that is an 8-digit code system, the descriptors such as ‘clothing’, ‘gender’ and ‘specific name’ are classified as the same higher nodes. Here, to express the articles of sports equipment, defined an additional node ‘sports equipment’ via node explosion process and then generate the code mask consisting of the higher nodes such as ‘clothing’, ‘gender’, ‘kind’ and ‘sports equipment’.

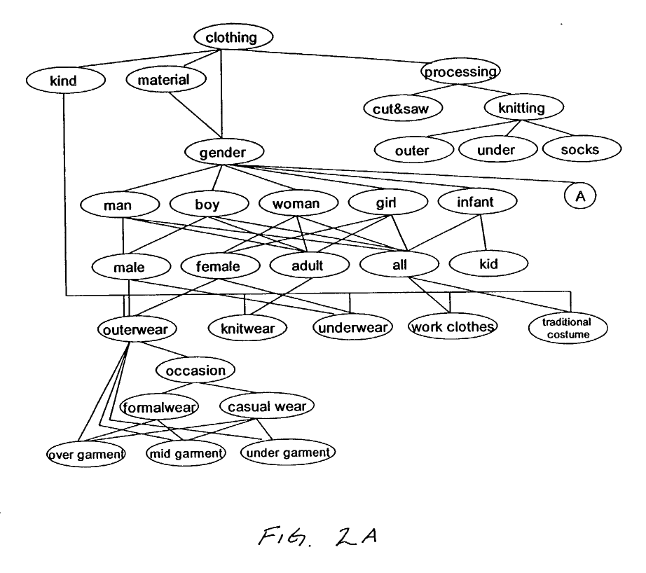

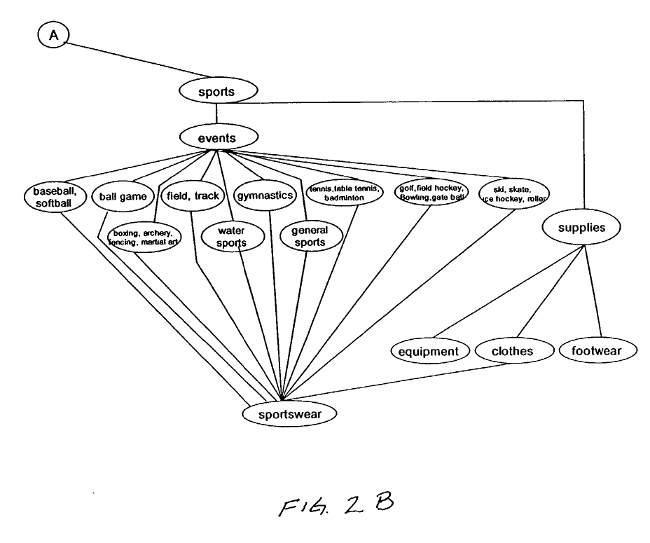

By using the node explosion process and the node contraction process where needed, generate the code masks for 4 types of article codes and extract the general descriptors such as ‘kind’, etc. from the code masks, which will be used as higher nodes if each code mask generated maximally express all the descriptors in each code system respectively. The general descriptors are extracted by the process of node raising. For example, in KAN code, the node “kind’ is classified as a mid-level node, but, for logical unification with other code systems, in the unification code system, the node are raised to the higher node as seen in FIG. 2A.

After judging that all the general descriptors are extracted by reflecting all the common notions in the code masks, extract the inherent discriminant descriptors in each code mask. For example, each descriptor such as ‘sports’ in KAN code, ‘material’ in HTS code and ‘processing’ in NAICS can be extracted as a discriminant descriptor. The discriminant descriptors are extracted by the process of node lowering; for example, in KAN code, the descriptor ‘sports’ is classified as a higher node, but, in the unification code system, the node are lowered to the mid-level node as seen in FIG. 2B.

If all the discriminant descriptors maximally express the descriptors in each code mask, complete the unification code mask by combining the general descriptor ‘kind’ and discriminant descriptors ‘material’ and ‘processing’ as seen in FIGS. 2A and 2B.

In what follows, construct the network between nodes in the unification code mask, which will express the interrelationship between classificatory nodes in each code mask. For example, the nodes ‘material’ and ‘gender’ in HTS are interrelated and also, in the unification code system, the node network will be constructed by linking these nodes.

Complete the unification code mask for the articles of clothing as seen in FIGS. 2A and 2B if the completed node network maximally express the interrelation between 4 existing code systems. That is to say, this unification code mask is constructed by hierarchically arranging the general descriptors and the discriminant descriptors extracted from 13 existing code systems and by considering the network that will express node relation between those systems. In case of the articles of ‘Y-shirts’, each existing code system has only one way of expressing the article ‘Y-shirt’, but, since the unification code mask inclusively integrates the code systems, there are many combinational ways of expressing it. That is, as in FIG. 2A, there are several ways of expressing the hierarchical linkage between nodes; a path with full specification (clothing→material→gender→man→male→outerwear→occasion→formalwear→innerwear); a path without nodes such as ‘material’, ‘occasion’, and ‘formalwear’ (clothing→gender→man→male→outerwear→innerwear); and a path without nodes such as ‘gender’, ‘material’ and ‘occasion’ (clothing→kind→outerwear→innerwear). Therefore, only by describing the classificatory characteristics of the KAN code on the article ‘Y-shirt’, it is possible to get code values in other code system (e.g. HTS code value 6205202022) and to represent the classificatory characteristics of the article ‘Y-shirt’ (e.g. ‘clothing’, ‘material’, ‘gender’ and ‘kind’). And the unification code mask makes the classificatory characteristics of the article map one another. Following table shows us the mapping relation between codes;

TABLE 1

| | | | | | Unification |
|---|---|---|---|---|---|
| | | | | | code (FIG. 1 |
| | HTS | NAICS | UN/SPSC | KAN | and FIG. 2) |
| Clothing | 62xxxxxxxx | 315xxx | 53xxxxxx | 5xxxxx | Mapping at |
| | | | | | clothing level |
| Kind | xxxxxx2022 | xxxxx3 | xxxx16xx | xxxx07 | Mapping at |
| | | | | | kind level |
| Gender | xx05xxxxxx | xxxx2x | xxxxx02 | xx04xx | Mapping at |
| | | | | | gender level |

| | | | | |
|---|---|---|---|---|
| Processing | N/A | xxx2xx | N/A | Mapping at |
| | | | | processing |
| | | | | level |

| | | | |
|---|---|---|---|
| Material | xxxx20xxxx | N/A | Mapping at |
| | | | material level |

Accordingly, the unification code system makes it possible to get code values in other code system not by inputting all the characteristics but by inputting only minimum characteristics needed.

After constructing the unification code mask, to make database for the unification code system, it is possible to make the unification code objects by integrating one or more classificatory nodes that exist in the unification code mask and are related with each other; for example, by combining the nodes such as ‘man’, ‘boy’, ‘woman’, ‘infant’ and ‘sports’ into one object node ‘gender’, the node ‘gender’ can be defined as a unification code object. If the unification code objects maximally express the classificatory characteristics that all the articles in the code system have, complete the process.

The Unification Code System comprises the following components; a computer for mounting the unification code-generating program; means for inputting the existing article codes (e.g. a scanner); and means for outputting the code that is generated by analyzing and unifying the existing article codes.

The above Unification Code System is used as follows; (a) decide the article types from the code systems standardized by each country, each region and each organization; (b) extract those codes of the article types from each system; (c) input the target codes by using the inputting means; (d) save them to the database; (e) run the unification code program; (f) select the codes to be unified from the saved article codes; and (g) make the program define the unification code objects. As we have stated above, if the unification code objects are defined by the unification code program, this invention, by retrieving those objects when needed, makes it easy for users to exchange information effectively in carrying B2B EC, by providing the unified article code that will be globally usable irrespective of countries, regions or organizations.

Those skilled in the art will recognize that the present invention has many applications, and that the present invention is not limited to the representative examples disclosed herein. Moreover, the scope of the present invention covers conventionally known variations and modifications, as would be known by those skilled in the art. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer readable Storage Medium having a unification code generating program, the program comprises;
(a) a first step of extracting unifiable descriptors that are existed in each target article code and then generating code masks for each code;
(b) a second step of defining general descriptors and discriminant descriptors by comparing the code masks generated at the first step;
(c) a third step of constructing unification code mask nodes by using the discriminant descriptors and then constructing a network between the unification code mask nodes and generating a unification code mask by using the network; and
(d) a fourth step of defining unification code objects by using the unification code mask generated at the third step.

2. The storage medium of claim 1, in which the code mask for all target codes are generated by iteratively performing a node explosion process and a node contraction process.

3. A Unification Code System comprising;
(a) a computer for defining a unification code object, the computer having the storage medium as recited in claim 1 loaded thereon;
(b) means for inputting each individually standardized article codes; and
(c) means for outputting the unification code that is generated by analyzing and unifying the existing article codes.

4. A method of using a unification code system comprising:
(a) deciding article types from code systems standardized by each country, each region and each organization;
(b) extracting target codes the article types from each system;
(c) inputting the target codes by using inputting means;
(d) saving the target codes to a database;
(e) running a unification code program as recited in claim 1;
(f) selecting the codes to be unified from saved article codes; and
(g) making the program define unification code objects.
